(19) United States
(12) Patent Application Publication
(10) Pub. No.: US 2016/0377823 A1
(43) Pub. Date: Dec. 29, 2016

(54) OPTICAL MODULE AND OPTICAL MODULE PACKAGE INCORPORATING A HIGH-THERMAL-EXPANSION CERAMIC SUBSTRATE

(71) Applicant: KYOCERA AMERICA INC, San Diego, CA (US)

(72) Inventors: Paul GARLAND, San Diego, CA (US); Satoru TOMIE, Kyoto (JP); Eiji WATANABE, Kokubu (JP); Nobuo TAKESHITA, San Diego, CA (US)

(21) Appl. No.: 15/192,657

(22) Filed: Jun. 24, 2016

Related U.S. Application Data
(60) Provisional application No. 62/184,555, filed on Jun. 25, 2015.

(51) Int. Cl. G02B 6/42; G02B 6/12

(52) U.S. Cl. CPC G02B 6/4272; G02B 6/12004; G02B 6/4253; G02B 6/4271; G02B 2006/12135

(57) ABSTRACT

An optical module includes a high-thermal-expansion ceramic substrate on which is mounted a planar lightwave circuit as well as at least one device component. The high-thermal-expansion ceramic substrate may be used in conjunction with a high-thermal-expansion metal in order to reduce thermal stress produced from the mismatch of thermal properties within the optical module. The high-thermal-expansion ceramic substrate may also be part of an optical module package which includes a die attach area, on which at least one device can be mounted, and a circuit pattern which electrically connects the at least one device to other at least one device components. A high-thermal-expansion metal may also be used with the high-thermal-expansion ceramic substrate in order to reduce the thermal stress that would otherwise exist in the optical module package.

### RELATED APPLICATIONS

The application claims priority to and the benefit of U.S. Provisional Patent Application Ser. No. 62/184,555, entitled “HIGH-THERMAL-EXPANSION CERAMIC OPTICAL MODULE”, filed on Jun. 25, 2015, and incorporated by reference in its entirety, herein.

### BACKGROUND

Planar lightwave circuit (PLC) devices are used as modulators for high capacity optical transmission applications. These applications are part of digital coherent optical systems used for trunk line and metro communications needed for gigabit Ethernet. As such, more cost effective solutions are needed as these optical systems increase in number and replace current systems. In general, smaller optical module and optical module packages tend to be more cost effective than larger ones. This is because these smaller modules and packages use less parts and materials. Smaller modules and packages may also make it easier to meet the flexible design requirements of multi-source agreements.

Ceramic materials have many properties that are suitable for use in optical modules and optical module packages. For example, ceramic materials are rigid, which is an important property for optical modules because ceramic materials can assist in maintaining alignment of the optical waveguide within the optical module. Also ceramic materials with a high coefficient of thermal expansion also provide a good match to printed wiring boards. However, ceramic materials also have low thermal conductivity. The low thermal conductivity of ceramic materials is not sufficient to manage the thermal path from active optical devices. If the thermal path from active optical devices is not managed adequately, then the reliability of the optical module and optical module package will be lower and failure of the optical module and optical module package may occur. Thus, there is a need for an improved optical module and optical module package, which can incorporate a high-thermal-expansion ceramic material in order to take advantage of that material's benefits while compensating for the materials low thermal conductivity so that there is thermal dissipation away from active optical devices.

### SUMMARY

An optical module includes a high-thermal-expansion ceramic substrate on which is mounted a planar lightwave circuit as well as at least one device component. The high-thermal-expansion ceramic substrate may be used in conjunction with a high-thermal-expansion metal in order to reduce thermal stress produced from the mismatch of thermal properties within the optical module. The high-thermal-expansion ceramic substrate may also be part of an optical module package which includes a die attach area, on which at least one device can be mounted, and a circuit pattern which electrically connects the at least one device to other at least one device components. A high-thermal-expansion metal may also be used with the high-thermal-expansion ceramic substrate in order to reduce the thermal stress that would otherwise exist in the optical module package.

### BRIEF DESCRIPTION OF THE DRAWINGS

It is to be understood that the drawings are solely for purpose of illustration and do not define the limits of the invention. Furthermore, the components in the figures are not necessarily to scale. In the figures, like reference numerals designate corresponding parts throughout the different views.

FIG. 1a is a cross-section of an optical module.

FIG. 1b is a cross-section of an optical module, including the optical module package, with a hermetic seal.

FIG. 2 is a perspective view of an optical module and optical module package with a hermetic seal.

FIG. 3 is a cross section of an optical module and optical module package with a non-hermetic seal.

FIG. 4 is a perspective view of an optical module and optical module package with a non-hermetic seal.

FIG. 5 is a perspective view of the optical module package without a device component attached.

FIG. 6 is an illustration depicting the flow of heat through the optical module and optical module package.

### DETAILED DESCRIPTION

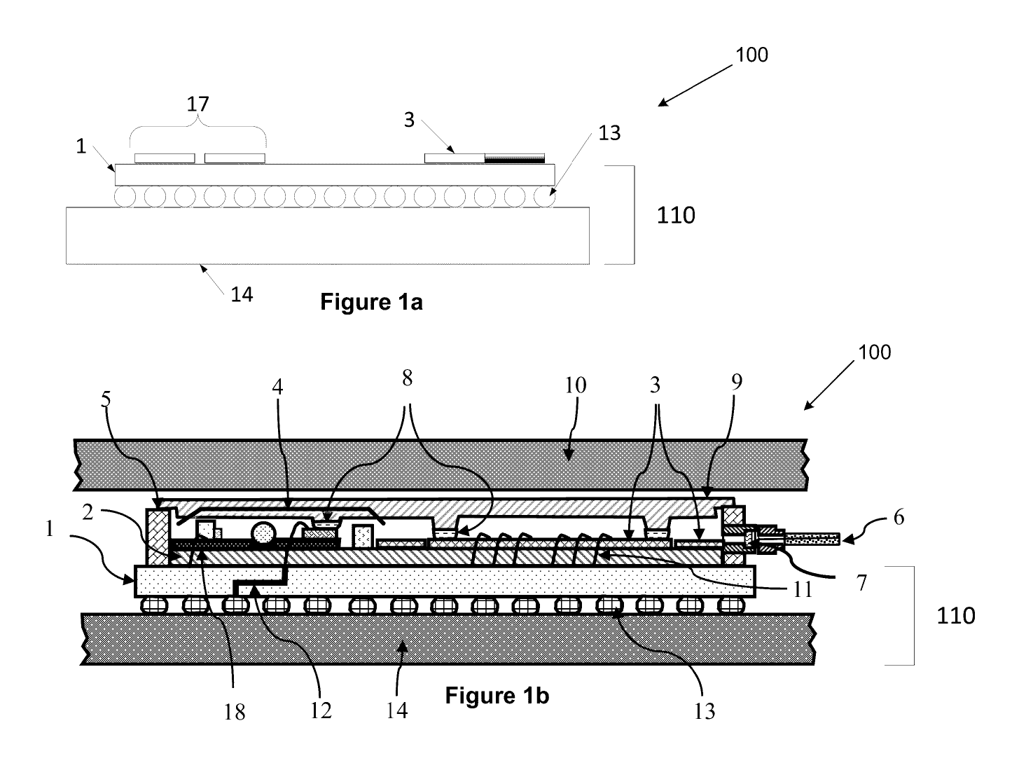

FIG. 1a is a cross section of an optical module 100. The optical module includes an optical module package 110 and device components 17 mounted on the optical module package 110. The Optical module package 110 includes a high-thermal-expansion circuit substrate 1 mounted on a printed wiring board 14 utilizing, for example, solder 13. The high-thermal-expansion circuit substrate 1 of the optical package 110 has a relatively high coefficient of thermal expansion (CTE). In one embodiment, the CTE ranges from 6.5 to 18 ppm/° C. In an example embodiment, a planar lightwave circuit (PLC) 3 is mounted on the high-thermal-expansion ceramic substrate 1 in addition to the device components 17. Examples of device components include laser diodes and photo diodes, driver devices, modulator, amplifier devices, demodulator devices and Large Scale Integrated (LSI) circuits.

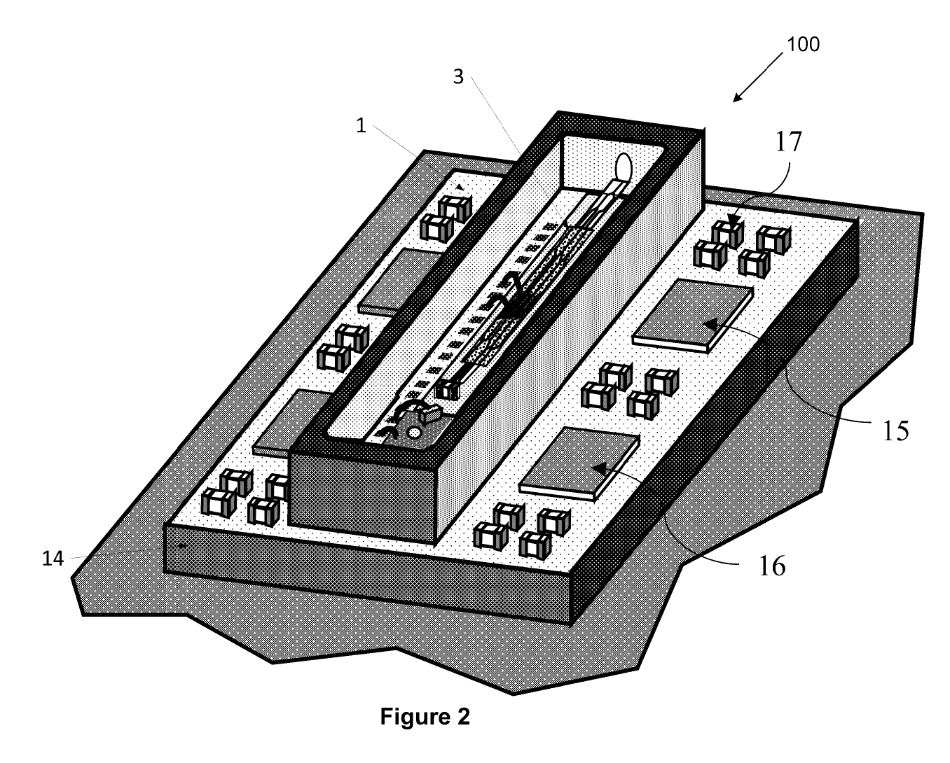

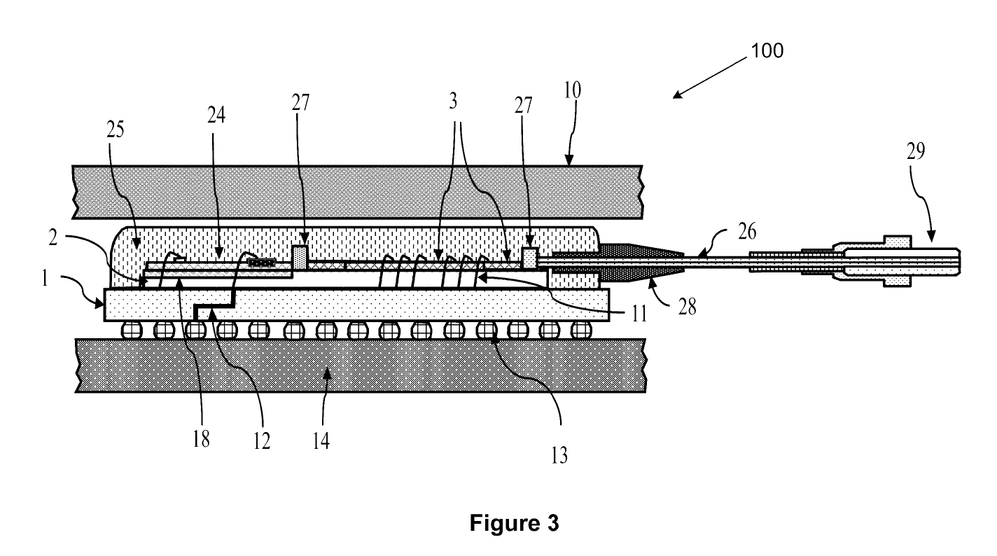

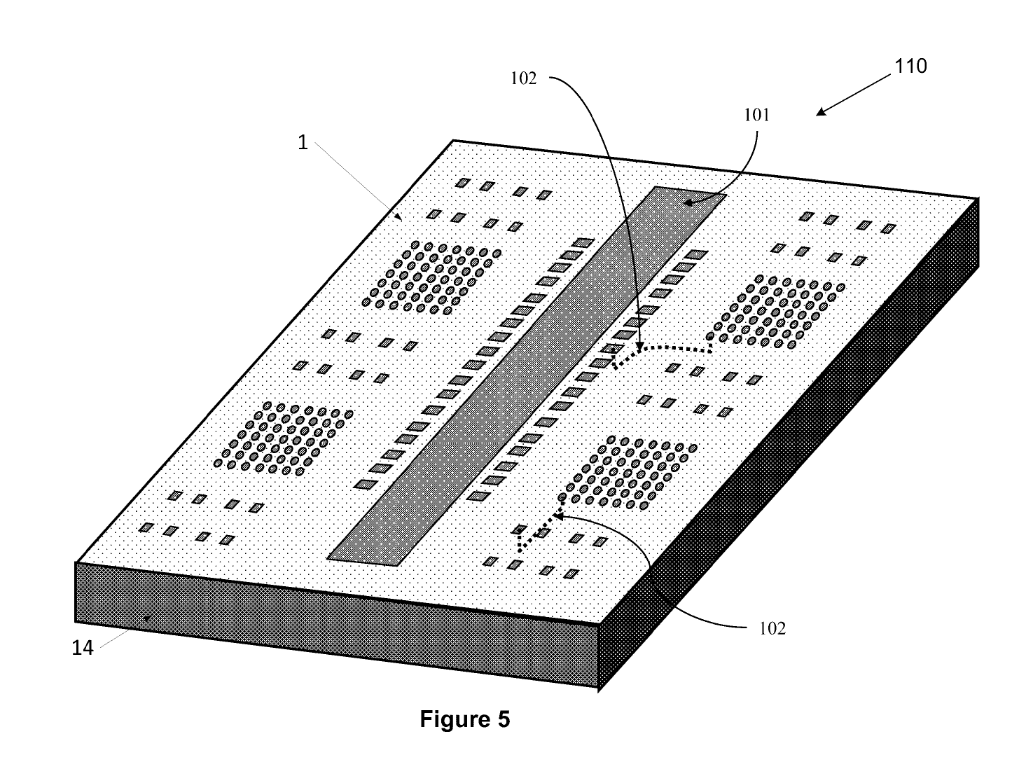

FIG. 1b depicts a cross-section of an embodiment of an optical module 100. Optical module 100 includes a high-thermal-expansion ceramic substrate 1. The high-thermal-expansion ceramic substrate 1 may also form a part of the optical module package 110. The high-thermal-expansion ceramic substrate 1 has a coefficient of thermal expansion (CTE) of 6.5 to 18 ppm/° C. In the optical module 100, a planar lightwave circuit (PLC) 3 is mounted on a die attach area 101 (as shown in FIG. 5) of the high-thermal-expansion ceramic substrate 1. The die attach area 101 can be located either on a surface of or within an internal cavity of the high-thermal-expansion ceramic substrate 1. A photonic integrated circuit (PIC) 24, as shown in FIG. 3, may also be mounted, in addition to or instead of PLC 3, on the die attach area 101 of the high-thermal-expansion ceramic substrate 1. PIC 24 generally consists of a laser diode, a photo diode, and a PLC. Additionally at least one device component is also mounted on the high-thermal-expansion ceramic substrate 1. Examples of device components include, but are not limited to, laser and photo diodes 4, driver and amplifier devices 15, and large scale integrated (LSI) circuits 16. Examples of LSI circuits include Digital Signal Processor (DSP) LSIs, Analog-Digital Converter (ADC) LSIs, Digital-Analog Converter (DAC) LSIs, Multiplexer (MUX) LSIs, De-multiplexer (DEMUX) LSIs, and Media Access Controller (MAC) LSIs. It is possible for different types of device components to be used in the same optical module. For example, FIG. 2 includes both driver and amplifier device 15, LSI circuit 16 along with other device components 17.

In the optical module package, the high-thermal-expansion ceramic substrate 1 may lie in the same plane as die attach area 101 and circuit pattern 102 as shown in FIG. 5. Die attach area 101 is a metallization square or rectangular pattern on the high-thermal-expansion ceramic substrate 1. The die attach area 101 can be located either on of the surface of high-thermal-expansion ceramic substrate 1, or within an inside cavity of the high-thermal-expansion ceramic substrate 1. Circuit pattern 102 comprises all connection patterns, including any VIA holes used for vertical transmissions on the high-thermal-expansion ceramic substrate 1. The circuit pattern 102 runs from the region on which PLC 3 is mounted to the region on which at least one device component 17 is mounted, thus connecting the device to the device component.

As shown in FIG. 1b, the optical module 100 also may include a thermal interface material 8, a frame 5, an optical fiber assembly 6, and optical window 7, a lid 9, a chassis 10, and an internal trace line 12. Solder 13, printed wiring board 14 and a heat sink 18 may also be used in both the optical module 100 and optical module package 110. The devices, components, substrate, board and package may be assembled and interconnected by using wire bond 11, but also by ribbon bonding, lead bonding, pin insertion, flip-chip method, solder, glass solder, sealer, glue, adhesive material, welding, and mechanical attachments.

The optical module 100 and optical module package 110 both include high-thermal-expansion ceramic substrate 1. High-thermal-ceramic substrate 1 has a relatively high CTE ranging from 6.5 to 18 ppm/° C. for temperatures ranging from 40° C. and 400° C. High-thermal-expansion ceramic substrate 1 may be comprised of glass ceramic, alumina, zirconia, forsterite, steatite, and titania. Both low-temperature and high-temperature fired ceramics may be used. The particular ceramic substrate used in a specific module or package should be chosen such that it matches favorably with the thermal properties of the devices mounted on it; that is, the CTE of high-thermal-expansion ceramic substrate 1 should be substantially similar to the devices mounted on it.

The optical module 100 and optical module package 110 may also include a high-thermal-expansion metal 2. The high-thermal-expansion metal 2 rests on top of high-thermal-expansion ceramic substrate 1. If a high-thermal-expansion metal 2 is used in conjunction with high-thermal-expansion ceramic substrate 1, then active devices and device components are mounted on top of the high-thermal-expansion metal 2 instead of the die attach area 101. The high-thermal-expansion metal 2 should also be chosen such that its CTE is substantially similar to the CTE of PLC 3. This increases the potential for good thermal management within both the optical module and optical module package. The high-thermal-expansion metal 2 may be comprised of any metal with a high CTE including but not limited to stainless steel, steel alloy, nickel, nickel alloy, iron, iron alloy, copper, copper alloy, aluminum, aluminum alloy, gold, gold alloy, silver, silver alloy, and brass. High-thermal-expansion metal 2 may be made via a rolled metal compound process as the rolled process can bring out different CTE in terms of different axes. Alternatively a heat sink 18, such as a thermoelectric cooler, may be used in place of high-thermal-expansion metal 2.

For example, PLC 3 is often constructed by using a ferroelectric material. The ferroelectric material of PLC 3 may be lithium niobate (LiNbO₃). Lithium niobate is anisotropic for thermal expansion. In order to ensure that the optical module operates properly, it is important that any stress from thermal mismatches to be minimized in optical module 100. If there is thermal stress, then optical transmission performance may worsen due to the change of the refractive index of PLC 3 due to the photoelastic effect. This may lead to optical transmission loss in a coherent optical system. More specifically, the axis of propagation for both light and RF waves is the z-axis. Therefore, the high-thermal-expansion metal 2 should have a CTE that is substantially similar to the CTE of lithium niobate in the z-axis in order to minimize thermal stress in the optical module. The CTE of the high-thermal expansion metal 2 may range from 6.5 to 18 ppm/° C. for temperatures ranging between 40° C. and 400° C. The CTE of lithium niobate is different from the CTE of other semiconductor devices. If PLC 3 is constructed from a different material, then the CTE of high-thermal-expansion ceramic substrate 1 and high-thermal-expansion metal 2, if also included, should be substantially similar to the CTE of the actual material used.

Thermal interface material 8 may also be included as part of the optical module 100 in order to increase the potential for good thermal management. Thermal interface material 8 is positioned between PLC 3 and the chassis 10. If the optical module 100 is also configured with lid 9, then the thermal interface material 8 may also be positioned such that the device 3 is below it while lid 9 and chassis 10 are both above it. A spacer or pillar may protrude from lid 9 and connect with thermal interface material 8 below it. The thermal interface material 8 may be comprised of materials such as conductive epoxy, non-conductive epoxy, silicone gel, and silicon greases

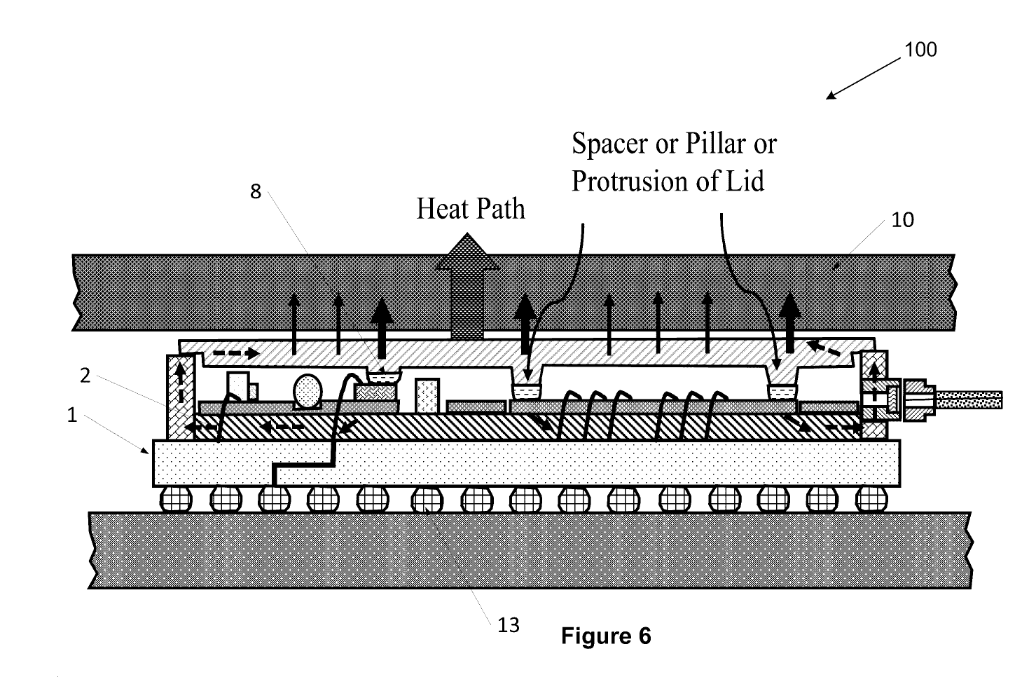

Thermal interface material 8 may provide a thermal path that directs heat from PLC 3 away from high-thermal-expansion ceramic substrate 1 and instead up through lid 9 or encapsulation material 25 and to chassis 10. As illustrated by FIG. 6, heat travels up through the optical module 100 and to chassis 10 because of the difference in the thermal conductivity of the different parts of the module. Solder 13 does not have high thermal conductivity, and neither does high-thermal-expansion ceramic substrate 1. However, high-thermal-expansion metal 2 has a higher thermal conductivity than high-thermal-expansion ceramic substrate 1. Thermal interface 8 has high thermal conductivity, but chassis 10 has the highest thermal conductivity in the optical module and optical module package. Heat moves from areas with lower thermal conductivity to areas with higher thermal conductivity, and this leads to heat from PLC 3 and other active optical devices, such as a laser diode, traveling up through thermal interface 8 and to chassis 10 rather than towards high-thermal-expansion ceramic substrate 1 and solder 13.

Good thermal stress management within the optical module 100 and optical module package 110 may allow for the reduction in size of the optical module and optical module package, which in turn makes it easier to match standards set under multi source agreements (MSA). For example, high-thermal-expansion ceramic substrate 1, die attach area 101, and circuit pattern 102 may be mounted on a printed wiring board 14. The high-thermal-expansion ceramic substrate 1 may be connected to printed wiring board 14 through solder 13. Printed wiring board 14 may have a CTE of 12 to 16 ppm/° C. for temperatures ranging between 40° C. and 400° C. Because the optical module 100 and optical module package 110 have good thermal stress performance and also because printed wiring board has a CTE that is substantially similar to high-thermal-expansion ceramic substrate 1, a ball-grid-array (BGA) structure may be used for the solder 13 connecting high-thermal-expansion ceramic substrate 1 to printed wiring board 14 as this may help reduce the size of the optical module 100 and optical module package 110. A BGA structure involves an array of tiny balls of solder which connect the printed wiring board 14 to the high-thermal-expansion ceramic substrate 1. The BGA structure can reduce the size of the optical module 100 because it allows for electrical connections to be made under the module rather than just around it. However, the BGA structure is vulnerable to failure due to bending caused by thermal stress within the optical module 100 and optical module package 110. In order to use a BGA structure within an optical module and its package 110, good thermal stress management is needed in order to prevent solder 13 from failing. Thus, the optical module and optical module package as described above may be reduced in size because their thermal stress properties enable the use of a BGA structure. While a BGA structure may be used for solder 13, other solder connection types may be used as appropriate.

Optical module 100 may be sealed hermetically or non-hermetically. If the optical module is sealed hermetically, then it may also include a lid 9 and a frame 5. Lid 9 sits above optical module 100 and below chassis 10. Frame 5 is included on the right end and the left end of optical module 100, filling the gap between lid 9 and high-thermal-expansion ceramic substrate 1. Lid 9 and frame 5 are comprised of at least one material selected from a group consisting of stainless steel, steel alloy, nickel, nickel alloy, iron, iron alloy, copper, copper alloy, aluminum, aluminum alloy, gold, gold alloy, silver, silver alloy, brass, and carbon. If optical module 100 is sealed non-hermetically, then encapsulation material 25, as shown in FIG. 3, covers the top and the sides of optical module 100 instead of the combination of lid 9 and frame 5. As shown in FIG. 1, optical module 100 may also include optical fiber assembly 6, optical window 7, wire bond 11, and internal trace line 12 when a hermetic configuration is used.

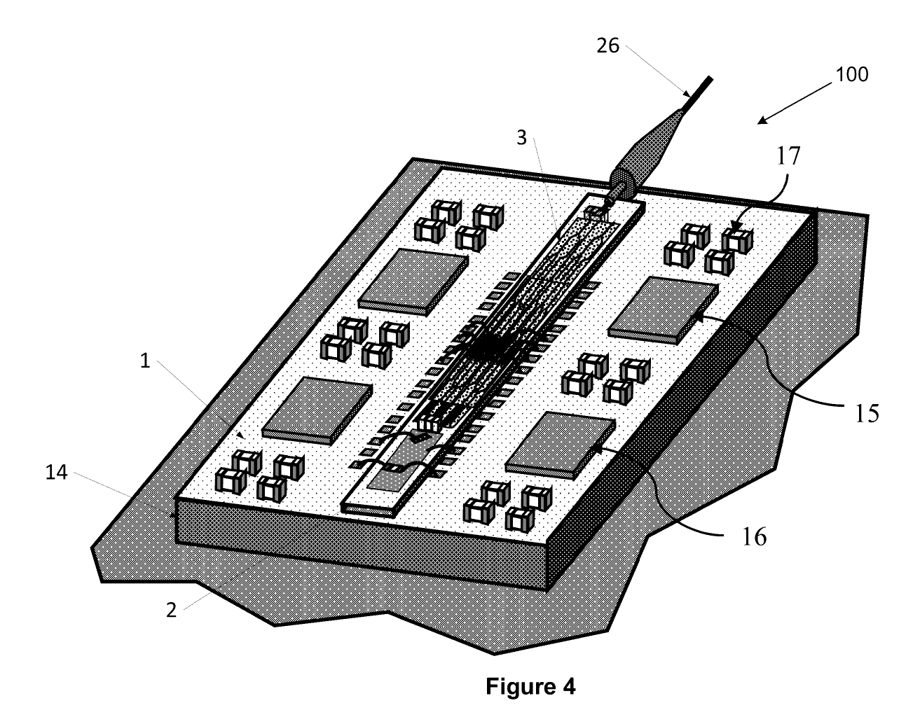

A non-hermetic configuration for optical module 100 may be appropriate when there is no air gap between the device components and PLC 3. Encapsulation material 25 covers the top and the sides of optical module 100 in a glove-top structure. As shown in FIG. 3, a non-hermetic configuration may also include PLC 3, PIC 24, optical component 27, fiber support 28, ferrule 29, and optical fiber assembly 26. Encapsulation material 25 has high thermal conductivity so that it can provide a thermal path that draws heat up from PLC 3, PIC 24 and away from high-thermal-expansion ceramic substrate 1 and solder 13. As shown in FIG. 3 and FIG. 4, optical fiber assembly 26 actually enters the interior of the optical module as opposed to optical fiber assembly 6 (shown in FIG. 1), which does not. This allows the optical paths to be arranged between the optical components 27 and the optical waveguide on PLC 3 and/or PIC 24 without any air gap.

Other advantages of the optical module 100 and package 110 may include better electrical performance because the dielectric loss angle of the high-thermal-expansion ceramic substrate 1 is lower than alternative materials. The rigidness of high-thermal-expansion ceramic substrate 1 may also provide an advantage because it is higher than the rigidness of alternative materials and so it may be more effective at maintaining the optical alignment to the lightwave to laser and the lightwave to fiber. Finally, it is advantageous for a high frequency electromagnetic wave to be provided from the optical waveguide to PLC 3 as this may assist in lowering optical performance loss due to the short length interconnection optimized design by internal trace line 12.

Other embodiments, combinations, and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. An optical module comprising:
a high-thermal-expansion ceramic substrate which has a coefficient of thermal expansion of 6.5 to 18 ppm/° C.;
a planar lightwave circuit mounted on the high-thermal-expansion ceramic substrate; and
at least one device component mounted on the high-thermal-expansion ceramic substrate.

2. The optical module of claim 1 wherein the at least one device component is selected from a group consisting of a laser diode, a photo diode, a driver device for a modulator, an amplifier device for a demodulator, and a Large Scale Integrated circuit (LSI).

3. The optical module of claim 1, further comprising a thermal interface material.

4. The optical module of claim 3, wherein the thermal interface material provides a thermal path from the at least one device component.

5. The optical module of claim 1 further comprising a high-thermal-expansion metal positioned between the high-thermal-expansion ceramic substrate and the planar lightwave circuit.

6. The optical module of claim 5, wherein the high-thermal-expansion metal has anisotropic thermal expansion in the Z-axis of 6.5 to 18 ppm/° C.

7. The optical module of claim 1, further comprising a hermetic seal, the hermetic seal enclosing the at least one device component.

8. The optical module of claim 7, further comprising a thermo-electric cooler.

9. The optical module of claim 1, further comprising a non-hermetic seal, the non-hermetic seal enclosing the at least one device component.

10. The optical module of claim 9, wherein the non-hermetic seal comprises a high thermal conductive encapsulation material.

11. The optical module of claim 1 wherein the high-thermal-expansion ceramic substrate is mounted on a printed wiring board with a coefficient of thermal expansion of 12 ppm/° C. to 16 ppm/° C.

12. An optical module package comprising:
a high-thermal-expansion ceramic substrate which has a coefficient of thermal expansion of 6.5 to 18 ppm/° C.;
a die attach area for mounting at least one device, and
a circuit pattern, for connecting the mounted at least one device to at least one device component.

13. The optical module package of claim 12, wherein the at least one device component is selected from a group consisting of a laser diode, a photo diode, a driver device for modulator, an amplifier device for modulator, or a largescale integrated circuit (LSI), and wherein the at least one device is either a planar lightwave circuit (PLC) or a photonic integrated circuit (PIC).

14. The optical module package of claim 13, further comprising a high-thermal-expansion metal positioned on the high-thermal-expansion ceramic substrate.

15. The optical module package of claim 14, wherein the high-thermal-expansion metal has anisotropic thermal expansion in the Z-axis of 6.5 to 18 ppm/° C.

16. The optical module package of claim 13, further comprising a hermetic seal, the hermetic seal enclosing the at least one device.

17. The optical module package of claim 16, further comprising a thermos-electric cooler.

18. The optical module package of claim 13, further comprising a non-hermetic seal, the non-hermetic seal enclosing the at least one device.

19. The optical module package of claim 18, wherein the non-hermetic seal comprises a high thermal conductive encapsulation material.

20. The optical module package of claim 13, wherein the high-thermal-expansion ceramic substrate is mounted on a printed wiring board with a coefficient of thermal expansion of 12 ppm/° C. to 16 ppm/° C.
